(19) United States
(12) Patent Application Publication
(10) Pub. No.: US 2002/0130516 A1
(43) Pub. Date: Sep. 19, 2002

(54) Anti-rotational pipe coupling system

(76) Inventor: Mark J. Sewell, Bethlehem, PA (US)

Correspondence Address: John A. Chionchio, Esquire, Synnestvedt & Lechner LLP, Suite 2600, 1101 Market Street, Philadelphia, PA, 19107-2950, US

(21) Appl. No.: 09/810,372

(22) Filed: Mar. 16, 2001

(51) Int. Cl. F16L 35/00

(52) U.S. Cl. 285/330

(57) ABSTRACT

An anti-rotational pipe coupling system is disclosed having pipe segments with end surfaces in which receptacles are arranged at spaced intervals circumferentially around each pipe. Interference bodies in the form of elongated pins are received within the receptacles of one pipe segment and extend outwardly from the end surface to engage complementary receptacles in another pipe segment arranged in facing engagement. The pins bear against the pipe segment sidewalls within the receptacles to prevent relative rotation of the pipe segments about a longitudinal axis coaxial with them. The pipe segments are received within a tube which uses flexible splines engaging concentrically aligned grooves in the tube and the pipe segments to prevent relative axial movement between the segments.

### FIELD OF THE INVENTION

This invention concerns a pipe coupling system for joining pipe segments end-to-end, the coupling system preventing relative rotation of the pipes about their longitudinal axes.

### BACKGROUND OF THE INVENTION

Piping networks for the conveyance of liquids, such as water, as well as other fluids, such as compressed gases, are used across a wide spectrum of industrial, mining and agricultural activities. Such networks may conveniently be constructed from pipe segments of various lengths having prepared ends adapted to be joined and sealed together by a mechanical coupling system.

In one such mechanical coupling system, shown in FIG. 1, pipe segments 20 are received within a tube 22. O-ring seals 24 (only one being shown) are positioned symmetrically between tube 22 and each pipe segment 20 effecting a fluid-tight seal at the joint. The tube 22 has an inner surface 26 with an inwardly facing groove 28 arranged symmetrically and proximate to each end (only one groove 28 being shown). Pipe segments 20 have an outwardly facing groove 30 which is brought into concentric alignment with inwardly facing groove 28 upon insertion of pipe segment 20 into tube 22. When the grooves 28 and 30 are concentrically aligned, a flexible spline 32 may be inserted through an aperture 34 in tube 22 in communication with inwardly facing groove 28. The spline is received within grooves 28 and 30 and is positioned circumferentially around the pipe segments 20. The spline engages both the tube and the pipe segments and prevents relative axial motion between them.

While the coupling system described has many advantages, it makes no provision for preventing relative rotational motion of the pipe segments 20 about their longitudinal axes 36. Certain applications, such as a coupling system for a well drop pipe described below, require that the pipes cannot rotate relative to each other.

The well drop pipe 38, shown in FIG. 2, extends within a well 40. At the drop pipe's lower end 42, a submersible pump 44 is mounted. Pump 44 is electrically powered and receives its power via an electrical cable 46 which extends into well 40 lengthwise along the drop pipe 38. Drop pipe 38 may be constructed of several pipe segments 20 coupled axially by the tube and spline system depicted in FIG. 1. Submersible pumps such as 44 have an impeller (not shown) which rotates about the longitudinal axis 36 of pipe segments 20 to pump water 48 from the well 40. Each time the pump starts, considerable torque is applied to spin the impeller. The torque may be as high as 1,500 ft-lbs for a 200 hp pump and results in an equal and opposite counter torque being applied to pipe segments 20. Since there is no provision for reacting the counter torque at the tube 22, the lower pipe segment 20a will rotate about its longitudinal axis 36 in response to the counter torque each time the pump starts. This unrestrained rotation of pipe segment 20a will cause the electrical cable 46 to wrap around the drop pipe 40 in a helix, eventually placing sufficient tension on the cable 46 to cause it to separate or pull out of the pump, causing a pump failure.

There is clearly a need for an improved mechanical coupling system which prevents relative rotation of the pipe segments joined by the system.

### SUMMARY AND OBJECTS OF THE INVENTION

The invention concerns an anti-rotational pipe coupling for preventing relative rotation between pipe segments joined together. In the coupling system, a pipe segment with a circumferential sidewall having a predetermined thickness defining an end surface positioned at an end of the pipe segment has a receptacle positioned in the sidewall at the end. The receptacle has an opening facing outwardly from the end surface. An interference body has a first portion sized to interfit within the receptacle and a second portion projecting outwardly from the receptacle beyond the end surface. The second portion of the interference body is engageable with another receptacle in an end surface of another pipe segment when the end surfaces are in facing engagement with one another. The interference body engages the receptacles in each pipe segment and prevents their relative rotation about a longitudinal axis coaxial with them.

Preferably, there are a plurality of such receptacles arranged in spaced relation to each other radially around the end surface of the pipe segment, and a plurality of interference bodies, each engageable with a respective receptacle.

In a preferred embodiment, the interference bodies comprise elongated cylindrical pins, the receptacles being cylindrical to receive the pins in mating engagement. One end of each pin interfits within a respective receptacle, the other end projects outwardly from the receptacle. Preferably, each pin has a longitudinal axis oriented substantially parallel to the longitudinal axis coaxial with the pipe segments to facilitate assembly and disassembly of the joint.

It is advantageous that one of the pins has a diameter relatively larger than the diameter of the receptacle into which it is received thereby providing an interference fit between the one pin and its receptacle to retain the pin with the pipe segment.

While the anti-rotational coupling system may be used in conjunction with various other mechanical coupling systems, it is particularly suited for use with a coupling system comprising an elongated tube having an inner diameter sized to receive the pipe segments in mating engagement. The pipe segments have an outwardly facing circumferential groove formed proximate to their respective ends. The tube has an inner surface with inwardly facing circumferential grooves positioned proximate each end thereof. The outwardly facing grooves in the pipe segments are positionable in concentric alignment with the inwardly facing grooves in the tube upon mating engagement of the pipe segments and the tube. Apertures are formed through the tube at each end in communication with the inwardly facing grooves. Each aperture receives an elongated flexible spline insertable through the aperture and positionable circumferentially around the tube within both the inwardly facing and outwardly facing grooves when the grooves are positioned in coaxial alignment. The splines engage both the tube and the pipe segments to prevent axial motion thereof relatively to one another.

It is an object of the invention to provide an anti-rotational coupling system that effectively prevents relative rotation of axially connected pipe segments about the longitudinal axes of the segments.

It is another object of the invention to provide an anti-rotational coupling system which is simple to install.

It is yet another object of the invention to provide an anti-rotational coupling system which is inexpensive to implement.

It is again another object of the invention to provide an anti-rotational coupling system which is reliable.

It is still another object of the invention to provide an anti-rotational coupling system which is compatible with currently available mechanical pipe coupling systems.

These and other objects and advantages will be apparent upon examination of the following drawings and detailed description of preferred embodiments of the invention.

### BRIEF DESCRIPTION OF THE DRAWINGS

FIG. 1 is a partial sectional perspective view of a prior art pipe coupling system;

FIG. 2 is a side view of a pipe coupling system of the prior art in operation;

FIG. 3 is a perspective view of an anti-rotational pipe coupling system according to the invention;

FIG. 4 is a cross-sectional view taken along lines 4-4 of FIG. 3;

FIG. 5 is a longitudinal sectional view of the anti-rotational pipe coupling system shown in FIG. 3;

FIG. 6 is a perspective view of the anti-rotational pipe coupling system shown in FIG. 3; and

FIGS. 7 and 8 show detailed components used in the anti-rotational pipe coupling system according to the invention.

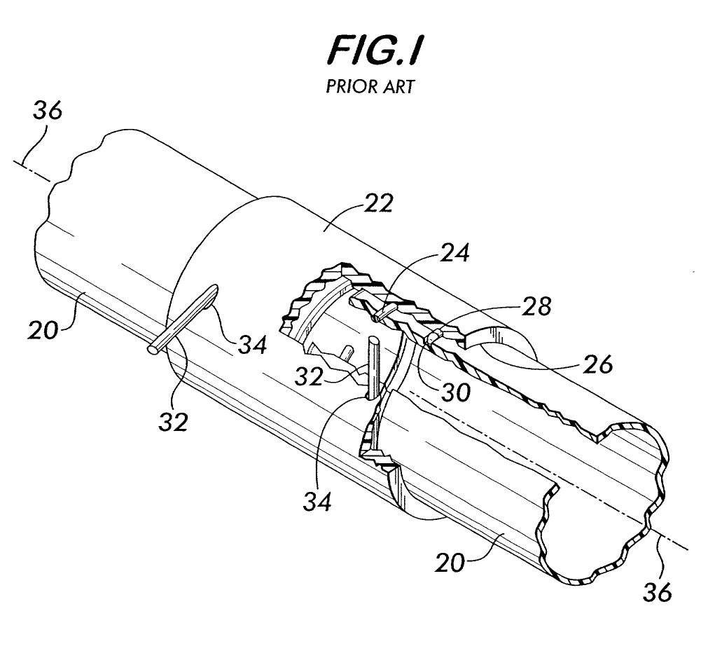

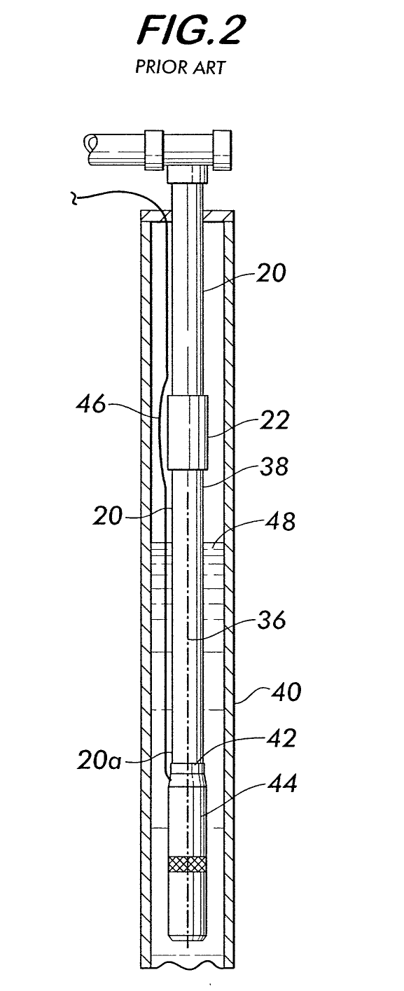

### DETAILED DESCRIPTION OF THE PREFERRED EMBODIMENT

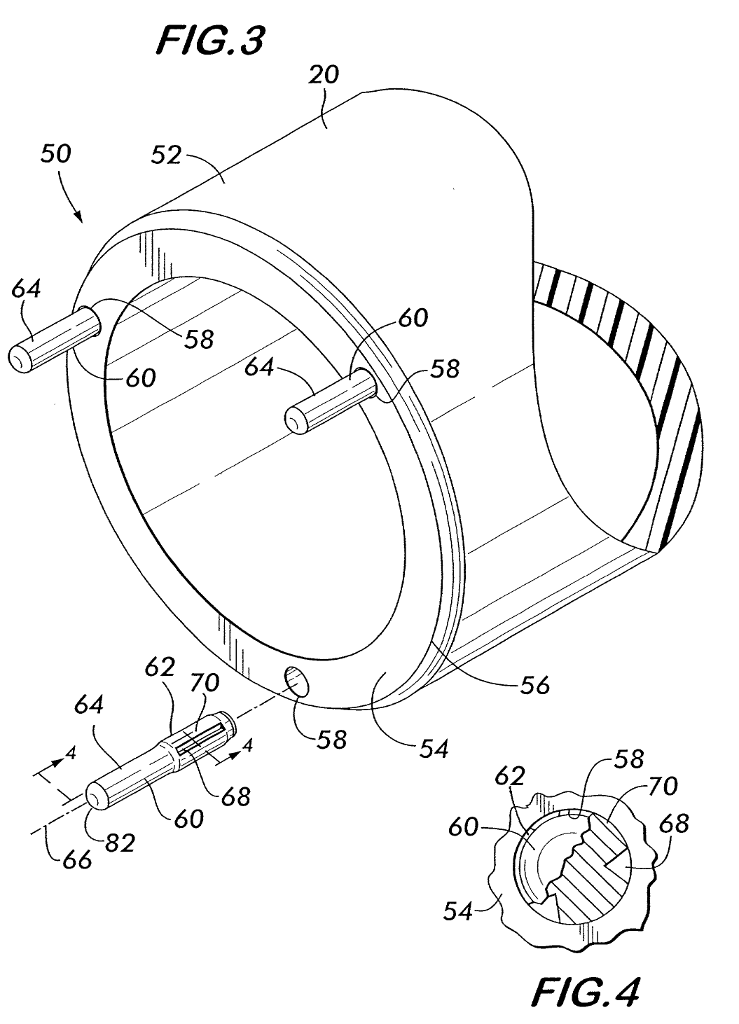

FIG. 3 shows a pipe segment 20 with the anti-rotational system 50 according to the invention. Pipe segment 20 has a circumferential side wall 52 with a predetermined thickness defining an end surface 54 positioned at an end 56 of the pipe segment. Anti-rotational system 50 comprises one or more receptacles 58 positioned in the sidewall 52 and facing outwardly from the end surface 54.

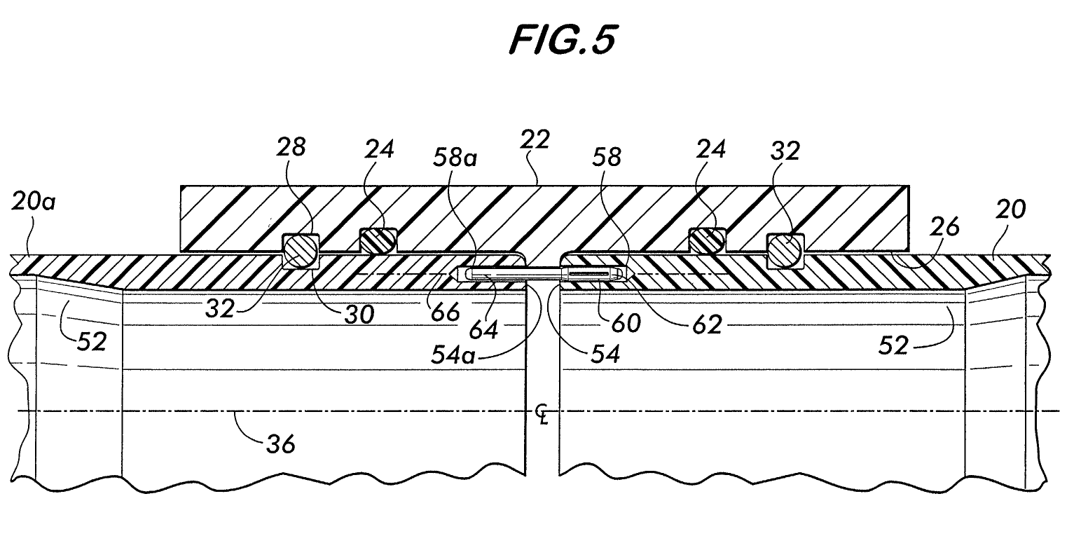

Receptacles 58 are sized and shaped to receive interference bodies 60, which are preferably elongated cylindrical pins described in detail below. Each receptacle 58 and a respective interference body 60 cooperate such that one portion 62 of the body interfits within the receptacle while another portion 64 extends outwardly from the receptacle 58 beyond the end surface 54. As shown in FIG. 5, the outwardly extending portion 64 of each body 60 is engageable with another receptacle 58a positioned in another end surface 54a of another pipe segment 20a when the end surfaces 54 and 54a are in facing engagement with one another. The interference body 60 bears on both pipe segments 20 and 20a and prevents relative rotation of the pipe segments about their longitudinal axes 36.

As noted above, interference bodies 60 are preferably elongated cylindrical pins, and the receptacles 58 are also cylindrical to receive the pins in mating engagement. Preferably, the pins have a longitudinal axis 66 which is oriented substantially parallel to longitudinal axis 36 of the pipe segments 20. Keeping the various axes parallel facilitates the coupling of the pipe segments together, allowing the pins 60 to slip into and out of mating engagement as required.

When the anti-rotational system is used in conjunction with an axial coupling means, such as the mechanical coupling system having tube 22 (see FIG. 5), the pins 60 are not visible once both pipe segments 20 and 20a are engaged with the tube 22, and it may, therefore, be difficult to align the pins 60 with the receptacles 58a in pipe segment 20a. However, the tube 22 cannot be secured to both of the pipe segments 20 and 20a by means of the flexible splines 32 unless the pins 60 are properly engaged within the receptacles because the outwardly facing groove 30 on at least one of the pipe segments will be prevented from properly aligning with the corresponding inwardly facing groove 28 on tube 22, thereby preventing insertion of the spline 32 through aperture 34. Only when the pins properly engage their respective receptacles do the outwardly facing grooves 30 align with the inwardly facing grooves 28 and permit insertion of the splines 32 to secure the pipe segments 20 and 20a to one another.

While it is possible to prevent relative rotation of the pipes about the longitudinal axis 26 with a single pin 60, it is preferred to use a plurality of pins as shown in FIG. 3. The number of pins and their diameter are selected so as to keep the bearing stresses in the circumferential sidewall 52 below a threshold value proportional to the bearing failure allowables for the particular material comprising the pipe segments 20. While the anti-rotational system is not limited to any particular material, it is particularly suitable for use with pipe segments 20 and tubes 22 made of engineering thermoplastics, PVC being preferred, but other materials including CPVC, polyethylene and fiberglass also being feasible. Pins 60 are preferably stainless steel due to this material's strength and resistance to corrosion. However, other non-corroding materials, including aluminum, coated steel (galvanized or plated), as well as high-strength engineering thermoplastics, are also feasible. Splines 32 are preferably also engineering thermoplastics, such as PDT for flexibility and strength.

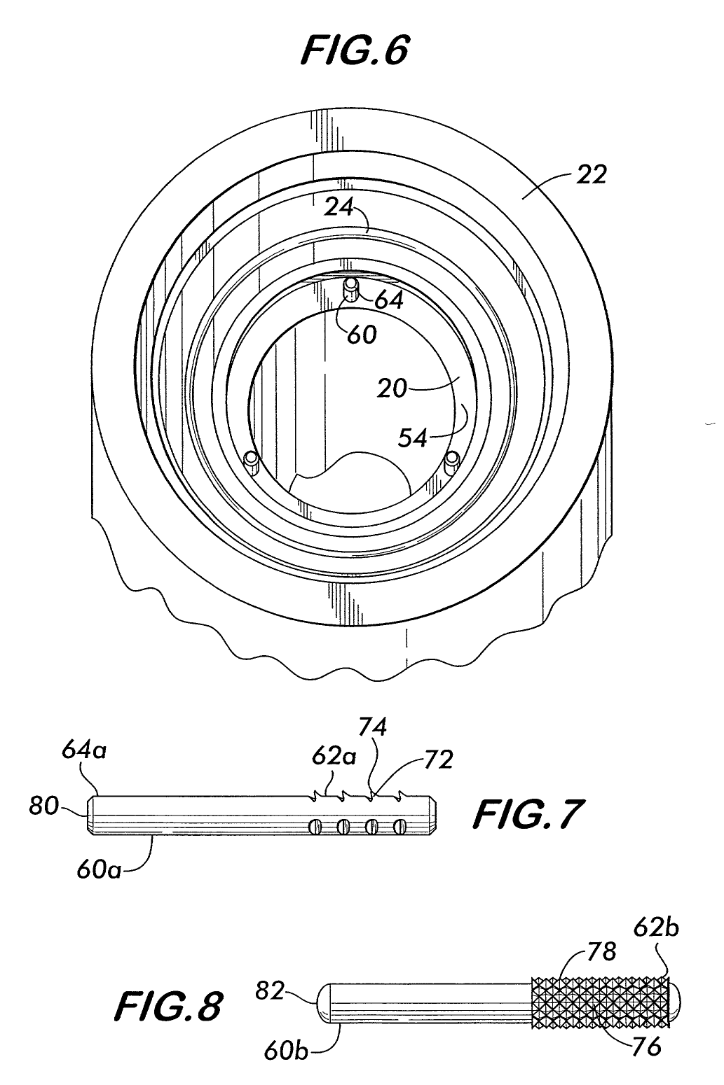

In assembling the anti-rotational pipe coupling system according to the invention, it is preferred to first engage the portion 62 of pins 60 in receptacles 58 on one pipe segment 20 as shown in FIG. 3, and then interfit pipe segment 20 into one end of tube 22 as shown in FIG. 6. To secure the pipe segment 20 to tube 22, flexible spline 32 is inserted into the concentrically aligned grooves 28 and 30 near the end of the tube receiving the pipe segment. Next, the other pipe segment 20a is interfitted into the other end of tube 22, the pins 60 are aligned with receptacles 58a in pipe segment 20a and the pipe segment 20a is pushed toward pipe segment 20, engaging the extending portion 64 of pins 60 with receptacles 58a as shown in FIG. 5. Once the pipe segments are properly engaged the other flexible spline 32 may be inserted into the concentrically aligned grooves 28 and 30 at the other end of the tube 22 to secure pipe segment 20a to it.

To facilitate assembly and disassembly of the joint and prevent loss of the pins, it is convenient to have the pins 60 interfit within receptacles 58 with some degree of interference. At the same time, it is desired to have the same pins slide relatively easily into and out of receptacles 58a in the adjoining pipe segment 20a. Both receptacles 58 and 58a should be the same size, however, so that all pipe segments are identical, thus, allowing any pipe segment to couple to any other segment.

These constraints are met by disrupting the surface of one of the aforementioned pin portions, for example, portion 62, to enlarge the pin portion by giving it a greater effective diameter. Thus, when enlarged pin portion 62 engages receptacle 58, as shown in FIG. 4, the larger effective diameter results in an interference fit between the pin and the receptacle, effectively retaining the pin in pipe segment 20. However, the remaining portion of the pin 64 is substantially unaffected and is sized relative to receptacle 58a to easily slide in and out with no significant interference. These properties of the pins facilitate engagement of the pins with the receptacles during assembly of the joint and prevent the pins from being lost during handling, assembly and disassembly of the pipe segments.

FIGS. 3, 4, 7 and 8 show several methods for disrupting the pin surface and obtaining a larger effective diameter over a portion of the pin. In the pin 60 shown in FIGS. 3 and 4, longitudinal grooves 68 are swaged into the surface of portion 62 at 120° intervals circumferentially around the pin. The swaging operation outwardly displaces metal on each side of the grooves, thus forming raised areas 70 between them. The raised areas 70 effectively expand the diameter of the pin over the portion 62 where the grooves 68 are located.

FIG. 7 shows another pin 60a, which has barbs 72 extending radially outwardly from a portion 62a of the pin and effectively increasing its diameter over that portion. Barbs 72 have a pointed end 74 which faces toward the other pin portion 64a. In operation, the barbed portion 62a is first inserted into the receptacle 58 of one of the pipe segments 20, the barb ends 74 engaging the pipe segment sidewall within the receptacle to retain the pin therein.

FIG. 8 shows yet another pin 60b wherein a portion of the pin 62b is knurled. The knurling operation disrupts the surface over portion 62b and produces a textured surface 76 comprising a plurality of projections 78 extending radially outwardly from the pin to create a larger effective diameter over portion 62b. When portion 62b of pin 60 is inserted into a receptacle 58, the projections effectively engage the pipe segment sidewall within the receptacle, again with the object of retaining the pin within the receptacle during handling, assembly and disassembly of the joint.

Other details which facilitate assembly of the pipe joint include countersinking the receptacles 58 and 58a. Countersunk receptacles provide a larger target and a funneling effect which guides the pin into the receptacle, making engagement between receptacle and pin easier to attain. Further refinements include chamfered pin ends 80, shown in FIG. 7, and crowned pin ends 82, shown in FIGS. 3 and 8. These details and refinements provide significant advantages to joint assembly, especially when constructing the joint in the field as is often the case.

The anti-rotational pipe coupling system according to the invention promises to provide a simple, cost effective and practical solution to the problem of preventing relative rotation between pipe segments joined by means of a mechanical coupling which does not otherwise prevent such relative motion.

What is claimed is:

1. An anti-rotational pipe coupling, comprising:
a pipe segment with a circumferential sidewall having a predetermined thickness defining an end surface positioned at an end of said pipe segment;
a receptacle positioned in said sidewall at said end, said receptacle having an opening facing outwardly from said end surface;
an interference body having a first portion sized to interfit within said receptacle and a second portion projecting outwardly from said receptacle beyond said end surface, said second portion being engageable with another receptacle in an end surface of another pipe segment when said end surfaces are in facing engagement with one another, said interference body engaging said receptacles and preventing relative rotation of said pipe segments about a longitudinal axis coaxial with said pipe segments.

2. An anti-rotational pipe coupling according to claim 1, wherein said end surface is oriented substantially perpendicularly to said longitudinal axis.

3. An anti-rotational pipe coupling according to claim 2, further comprising a plurality of said receptacles arranged in spaced relation to each other radially around said end surface, and a plurality of said interference bodies, each engageable with a respective receptacle.

4. An anti-rotational pipe coupling according to claim 3, wherein said interference bodies comprise elongated cylindrical pins, said receptacles being cylindrical to receive said pins in mating engagement, one end of each pin comprising said first portion interfitting within said receptacle, the other end of said pin projecting outwardly from said receptacle, each of said pins having a longitudinal axis oriented substantially parallel to said longitudinal axis coaxial with said pipe segment.

5. An anti-rotational pipe coupling according to claim 4, wherein one of said pins has a diameter relatively larger than the diameter of said receptacles thereby providing an interference fit between said one pin and said receptacle.

6. An anti-rotational pipe coupling according to claim 5, wherein said larger diameter of said one pin is confined to said first portion thereof.

7. An anti-rotational pipe coupling according to claim 4, wherein one of said pins has a barb positioned on said first portion and extending radially outwardly therefrom, said barb having a pointed end facing toward said second portion for engaging said sidewall within said receptacle and preventing extraction of said one pin from said receptacle.

8. An anti-rotational pipe coupling according to claim 4, wherein said first portion of one of said pins has a textured surface extending circumferentially there around, said textured surface comprising a plurality of projections extending substantially radially outwardly for engaging said sidewall within said receptacle and preventing extraction of said one pin from said receptacle.

9. An anti-rotational pipe coupling according to claim 1, further comprising:
an outwardly facing circumferential groove formed in said pipe segment proximate to said end;
a tube having an inner diameter sized to receive said pipe segment in mating engagement, said tube having an inner surface with an inwardly facing circumferential groove positioned proximate one end thereof, said outwardly facing groove in said pipe segment being positionable in concentric alignment with said inwardly facing groove upon mating engagement of said pipe segment and said tube;
an aperture through said tube in communication with said inwardly facing groove; and
an elongated flexible spline insertable through said aperture and positionable circumferentially around said tube within both said inwardly facing and outwardly facing grooves when said grooves are positioned in coaxial alignment, said spline engaging both said tube and said pipe segment to prevent axial motion thereof relatively to one another.

10. An anti-rotational pipe coupling according to claim 9, wherein said inner surface has another inwardly facing circumferential groove positioned proximate to the other end of said tube, said tube having another aperture therethrough in communication with said other inwardly facing circumferential groove, another outwardly facing groove in another of said pipe segments being positionable in concentric alignment with said other inwardly facing groove upon mating engagement of said other pipe segment and said tube, another flexible spline being insertable through said other aperture and positionable circumferentially around said tube within both said other inwardly and outwardly facing grooves when said other grooves are positioned in coaxial alignment, said spline engaging both said tube and said other pipe segment to prevent axial motion thereof relatively to one another, said inwardly facing grooves being positioned in spaced relation to one another such that said interference bodies engage said receptacles in both of said pipe segments when each one of said inwardly facing grooves are in coaxial alignment with a respective one of said outwardly facing grooves on each of said pipe segments.

11. An anti-rotational pipe coupling, comprising:
a pipe segment with a circumferential sidewall having a predetermined thickness defining an end surface positioned at an end of said pipe segment;
a receptacle positioned in said sidewall at said end, said receptacle having an opening facing outwardly from said end surface; and
an elongated pin having a first portion sized to interfit within said receptacle and a second portion projecting outwardly from said receptacle beyond said end surface, said second portion being engageable with another receptacle in an end surface of another pipe segment when said end surfaces are in facing engagement with one another, said pin engaging said receptacles and preventing relative rotation of said pipe segments about a longitudinal axis coaxial with said pipe segments.

12. An anti-rotational pipe coupling according to claim 11, further comprising a plurality of said receptacles arranged in spaced relation to each other radially around said end surface, and a plurality of said pins, each engageable with a respective receptacle.

13. An anti-rotational pipe coupling according to claim 12, wherein each said pin has a cylindrical shape, said receptacles being cylindrical to receive said pins in mating engagement and having a longitudinal axis oriented substantially parallel to said longitudinal axis coaxial with said pipe segment.

14. An anti-rotational pipe coupling according to claim 13, wherein one of said pins has a diameter relatively smaller than the diameter of said receptacles thereby providing a loose fit between said one pin and said receptacles.

15. An anti-rotational pipe coupling according to claim 14, wherein said relatively smaller diameter of said one pin is confined to said second portion thereof.

16. An anti-rotational pipe coupling according to claim 11, further comprising:
an outwardly facing circumferential groove formed in said pipe segment proximate to said end;
an elongated tube having an inner diameter sized to receive said pipe segment in mating engagement, said tube having an inner surface with an inwardly facing circumferential groove positioned proximate one end thereof, said outwardly facing groove in said pipe segment being positionable in concentric alignment with said inwardly facing groove upon mating engagement of said pipe segment and said tube;
an aperture through said tube in communication with said inwardly facing groove; and
an elongated flexible spline insertable through said aperture and positionable circumferentially around said tube within both said inwardly facing and outwardly facing grooves when said grooves are positioned in coaxial alignment, said spline engaging both said tube and said pipe segment to prevent axial motion thereof relatively to one another.

17. An anti-rotational pipe coupling according to claim 16, wherein said inner surface has another inwardly facing circumferential groove positioned proximate to the other end of said tube, said tube having another aperture therethrough in communication with said other inwardly facing circumferential groove, another outwardly facing groove in another of said pipe segments being positionable in concentric alignment with said other inwardly facing groove upon mating engagement of said other pipe segment and said tube, another flexible spline being insertable through said other aperture and positionable circumferentially around said tube within both said other inwardly and outwardly facing grooves when said other grooves are positioned in coaxial alignment, said spline engaging both said tube and said other pipe segment to prevent axial motion thereof relatively to one another, said inwardly facing grooves being positioned in spaced relation to one another such that said interference bodies engage said receptacles in both of said pipe segments when each one of said inwardly facing grooves are in coaxial alignment with a respective one of said outwardly facing grooves on each of said pipe segments.

18. An anti-rotational pipe coupling, comprising:
a pipe segment with a circumferential sidewall having a predetermined thickness defining an end surface positioned at an end of said pipe segment;
a receptacle positioned in said sidewall at said end, said receptacle having an opening facing outwardly from said end surface;
an interference body having a first portion sized to interfit within said receptacle and a second portion projecting outwardly from said receptacle beyond said end surface, said second portion being engageable with another receptacle in an end surface of another pipe segment when said end surfaces are in facing engagement with one another, said interference body engaging said receptacles and preventing relative rotation of said pipe segments about a longitudinal axis coaxial with said pipe segments; and
axial coupling means engageable with said pipe segments for preventing relative axial motion between said pipe segments.

19. An anti-rotational pipe coupling according to claim 18, wherein said axial coupling means comprises:
an outwardly facing circumferential groove formed in said pipe segment proximate to one end thereof;
an elongated tube having an inner diameter sized to receive said pipe segment in mating engagement, said tube having an inner surface with an inwardly facing circumferential groove positioned proximate one end thereof, said outwardly facing groove in said pipe segment being positionable in concentric alignment with said inwardly facing groove upon mating engagement of said one pipe segment and said tube;
an aperture through said tube in communication with said inwardly facing groove; and
an elongated flexible spline insertable through said aperture and positionable circumferentially around said tube within both said inwardly facing and outwardly facing grooves when said grooves are positioned in coaxial alignment, said spline engaging both said tube and said pipe segment to prevent axial motion thereof relatively to one another.

20. An anti-rotational pipe coupling according to claim 19, wherein said inner surface has another inwardly facing circumferential groove positioned proximate to the other end of said tube, said tube having another aperture therethrough in communication with said other inwardly facing circumferential groove, another outwardly facing groove in said other of said pipe segments being positionable in concentric alignment with said other inwardly facing groove upon mating engagement of said other pipe segment and said tube, another flexible spline being insertable through said other aperture and positionable circumferentially around said tube within both said other inwardly and outwardly facing grooves when said other grooves are positioned in coaxial alignment, said spline engaging both said tube and said other pipe segment to prevent axial motion thereof relatively to one another, said inwardly facing grooves being positioned in spaced relation to one another such that said interference bodies engage said receptacles in both of said pipe segments when each one of said inwardly facing grooves are in coaxial alignment with a respective one of said outwardly facing grooves on each of said pipe segments.

21. An anti-rotational pipe coupling for preventing relative rotation between two pipe segments, each pipe segment having a respective circumferential sidewall with a predetermined thickness defining a respective end surface, said respective end surfaces being arrangable in facing engagement, said anti-rotational pipe coupling comprising:
a first receptacle positionable in one of said sidewalls and having an opening positionable to face outwardly from said respective end surface of said one sidewall;
a second receptacle positionable in the other of said sidewalls and having an opening positionable to face outwardly from said respective end surface of said other sidewall; and
an interference body having first and second portions sized to interfit respectively within said first and second receptacles when said respective end surfaces are in facing engagement with one another, said interference body engaging said receptacles and preventing relative rotation of said pipe segments about a longitudinal axis coaxial with said pipe segments.

22. An anti-rotational pipe coupling according to claim 21, wherein said interference body comprises an elongated cylindrical pin, said receptacles being cylindrical and capable of receiving said pin in mating engagement, said pin having a longitudinal axis orientable substantially parallel to said longitudinal axis when engaging said receptacles.

23. An anti-rotational pipe coupling according to claim 22, further comprising a plurality of said receptacles arrangable in spaced relation to each other radially around each of said end surfaces, and a plurality of said pins, each engageable with a respective pair of said receptacles.

24. An anti-rotational pipe coupling for preventing relative rotation between two pipe segments, each pipe segment having a respective circumferential sidewall with a predetermined thickness defining a respective end surface, said respective end surfaces being arrangable in facing engagement, said anti-rotational pipe coupling comprising:
a first receptacle positionable in one of said sidewalls and having an opening positionable to face outwardly from said respective end surface of said one sidewall;
a second receptacle positionable in the other of said sidewalls and having an opening positionable to face outwardly from said respective end surface of said other sidewall;
an interference body having first and second portions sized to interfit respectively within said first and second receptacles when said respective end surfaces are in facing engagement with one another, said interference body engaging said receptacles and preventing relative rotation of said pipe segments about a longitudinal axis coaxial with said pipe segments; and
axial coupling means engagable with said pipe segments for preventing relative axial motion between said pipe segments.

25. An anti-rotational pipe coupling according to claim 24, wherein said axial coupling means comprises:
an outwardly facing circumferential groove formed in each of said pipe segments proximate to one end thereof;
a tube having an inner diameter sized to receive said pipe segments in mating engagement, said tube having an inner surface with a pair of inwardly facing circumferential grooves, one of said groves being positioned proximate to each end of said tube, said outwardly facing groove in each said pipe segment being positionable in concentric alignment with one of said inwardly facing grooves upon mating engagement of said one pipe segment and said tube;
a pair of apertures extending through said tube, each said aperture being in communication with one of said inwardly facing grooves; and
a pair of elongated flexible splines, each of said splines being insertable through one of said said apertures and positionable circumferentially around said tube within one of said inwardly facing and outwardly facing grooves when said grooves are positioned in coaxial alignment, said splines engaging both said tube and said pipe segments to prevent axial motion thereof relatively to one another.
